(19) United States
(12) Patent Application Publication
(10) Pub. No.: US 2017/0295984 A1
(43) Pub. Date: Oct. 19, 2017

(54) METHOD AND DEVICE FOR EXAMINING BEVERAGE BREWING AND EXTRACTING PROCESS

(71) Applicant: acaia Corporation, Cupertino, CA (US)

(72) Inventor: Rex Poway TSENG, Cupertino, CA (US)

(73) Assignee: acaia Corporation, Cupertino, CA (US)

(21) Appl. No.: 15/283,885

(22) Filed: Oct. 3, 2016

(30) Foreign Application Priority Data
Apr. 13, 2016 (TW) 105111561

(51) Int. Cl. A47J 31/00

(52) U.S. Cl. CPC A47J 31/002

(57) ABSTRACT

A method for examining beverage brewing and extracting process includes the steps of adding a solvent to a solute, mixing the solvent and the solute together to produce a solution, and subjecting the solution to an extraction process to output an extract liquid; measuring a solvent weight increase per unit time of the added solvent and measuring an extract liquid weight increase per unit time of the output extract liquid at the same time during the step of adding the solvent to the solute; and performing a calculation on the solvent weight increase and the extract liquid weight increase to output a graphic data to represent the extraction process. By referring to the graphic data, even an inexperienced brewing operator can always ensure a consistent taste for the brewed solution.

### FIELD OF THE INVENTION

The present invention relates to a method for examining beverage brewing and extracting process, and more particularly to a beverage brewing and extracting process examining method, in which a calculation is performed on a solvent input quantity and an extract liquid output quantity to output a graphic data that represents the process of extraction.

### BACKGROUND OF THE INVENTION

Some leisure drinks, such as coffee, red tea and green tea, can be processed into powdered products. These powdered products can be put in a beverage extraction machine and mixed with hot water added thereto. The mixture is then subjected to an extraction process to produce a hot beverage, such as hot coffee, hot red tea or hot green tea.

The taste of a hot beverage is often influenced by the speed at which the hot water is poured into the beverage extraction machine and the speed at which the hot beverage extracted from the powder-water mixture flows out of the beverage extraction machine. Therefore, an inexperienced brewing operator frequently fails to ensure a consistent taste for the brewed and extracted hot beverage. Normally, a cup of brewed and extracted hot beverage that has an inconsistent taste will be directly discarded and another new cup of hot beverage is prepared and served. The discarded hot beverage inevitably increases the operating cost of the hot beverage shop.

In view that an inexperienced brewing operator might fail to ensure a consistent taste for the brewed and extracted hot beverage, it is desirable to develop an examining mechanism, with the help of which even an inexperienced person can always ensure a consistent taste for the brewed and extracted hot beverage.

### SUMMARY OF THE INVENTION

A primary object of the present invention is to provide a method for examining beverage brewing and extracting process, in which a graphic data can be output and used as a beverage brewing reference, and a brewing operator can always ensure a consistent taste for the brewed beverage by referring to the graphic data.

To achieve the above and other objects, the method for examining beverage brewing and extracting process according to a preferred embodiment of the present invention is implemented using a device for examining beverage brewing and extracting process. The examining device includes an extract liquid container, a first measurement unit, an extraction unit, a support frame, a second measurement unit, and an algorithm device.

The first measurement unit is located under the extract liquid container for measuring a container-alone weight of the extract liquid container. The extraction unit is located above the extract liquid container and has a solvent inlet, an extract liquid outlet, and a receiving space defined in the extraction unit between the solvent inlet and the extract liquid outlet. The support frame includes a base portion and a set of spaced leg portions, and the base portion is located between the first and the second measurement unit. Each of the leg portions is connected at an end to the base portion and at another end to the extraction unit, such that a spacing distance is kept between the extraction unit and the extract liquid container

The second measurement unit is located beneath the base portion of the support frame for measuring a total weight of the extract liquid container, the first measurement unit, the extraction unit and the support frame. The algorithm device is wirelessly connected to the first and the second measurement device simultaneously.

The method for examining beverage brewing and extracting process according to a preferred embodiment of the present invention includes the steps of adding a solvent to a solute, mixing the solvent and the solute together to produce a solution, and subjecting the solution to an extraction process to output an extract liquid; measuring a solvent weight increase per unit time of the added solvent and measuring an extract liquid weight increase per unit time of the output extract liquid at the same time during the step of adding the solvent to the solute; and performing a calculation on the solvent weight increase and the extract liquid weight increase to output a graphic data to represent the extraction process.

The solvent can be added to the solute continuously or intermittently. A total solvent weight of the solvent added to the solute is larger than a total extract liquid weight of the produced extract liquid. The graphic data includes a solvent input curve, an extract liquid output curve, a plurality of weight difference straight lines, an average weight of solvent input, an average weight of extract liquid output, and an average extraction time.

The examining method according to the preferred embodiment of the present invention further includes a reset step prior to the step of adding the solvent to the solute. The first measurement unit and the second measurement unit are reset to zero in the reset step, so that the first measurement unit will not measure a weight of the extract liquid container in the subsequent measuring step and the second measurement unit will not measure a total weight of the extraction unit and the extract liquid container in the subsequent measuring step.

The solvent is added to the extraction unit in which the solute is placed. The solvent and the solute are mixed together in the extraction unit to produce the solution; the produced solution is subjected to the extraction process in the extraction unit to output the extract liquid; and the extract liquid flows from the extraction unit into the extract liquid container.

During the step of adding the solvent to the solute, the second measurement unit measures an overall weight increase of the extraction unit and the extract liquid container per unit time; meanwhile the first measurement unit measures a container-alone weight increase of the extract liquid container per unit time. The algorithm device performs a calculation on the container-alone weight increase and the overall weight increase of the extraction unit and the extract liquid container to output the graphic data.

The first measurement unit and the second measurement unit simultaneously transmit the container-alone weight increase per unit time and the overall weight increase of the extraction unit and the extract liquid container per unit time, respectively, measured at the same time point to the algorithm device; and the algorithm device performs the calculation on the container-alone weight increase per unit time and the overall weight increase of the extraction unit and the extract liquid container per unit time that are measured at the same time point.

The present invention is characterized in measuring the solvent weight increase per unit time of the added solvent and the extract liquid weight increase per unit time of the output extract liquid at the same time during the step of adding the solvent to the solute; and performing the calculation on the solvent weight increase and the extract liquid weight increase to output the graphic data to represent the extraction process. By referring to the graphic data, a brewing operator can always ensure a consistent taste for the brewed beverage.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 is a block diagram showing the steps included in a method according to a preferred embodiment of the present invention for examining beverage brewing and extracting process;

FIG. 2 is a perspective view of a device according to a preferred embodiment of the present invention for examining beverage brewing and extracting process;

FIG. 3 is a pictorial description of the Reset step shown in FIG. 1;

FIG. 4 is a pictorial description of the Brewing step shown in FIG. 1;

FIG. 5 is a pictorial description of the Measuring step shown in FIG. 1;

FIG. 6 shows an example of graphic data created in the Graphing step shown in FIG. 1;

FIG. 7 shows the graphic data of FIG. 6 also includes data of average weight of solvent input (g/s), average weight of extract liquid output (g/s) and average extraction time (s); and

FIG. 8 shows another graphic data created in the Graphing step shown in FIG. 1.

### DETAILED DESCRIPTION OF THE PREFERRED EMBODIMENTS

The present invention will now be described with a preferred embodiment thereof and by referring to the accompanying drawings.

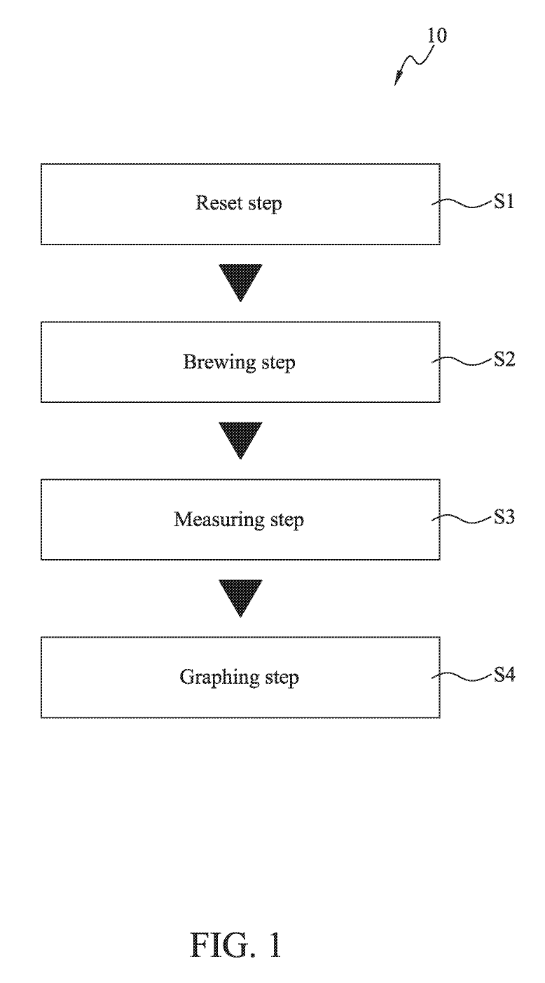

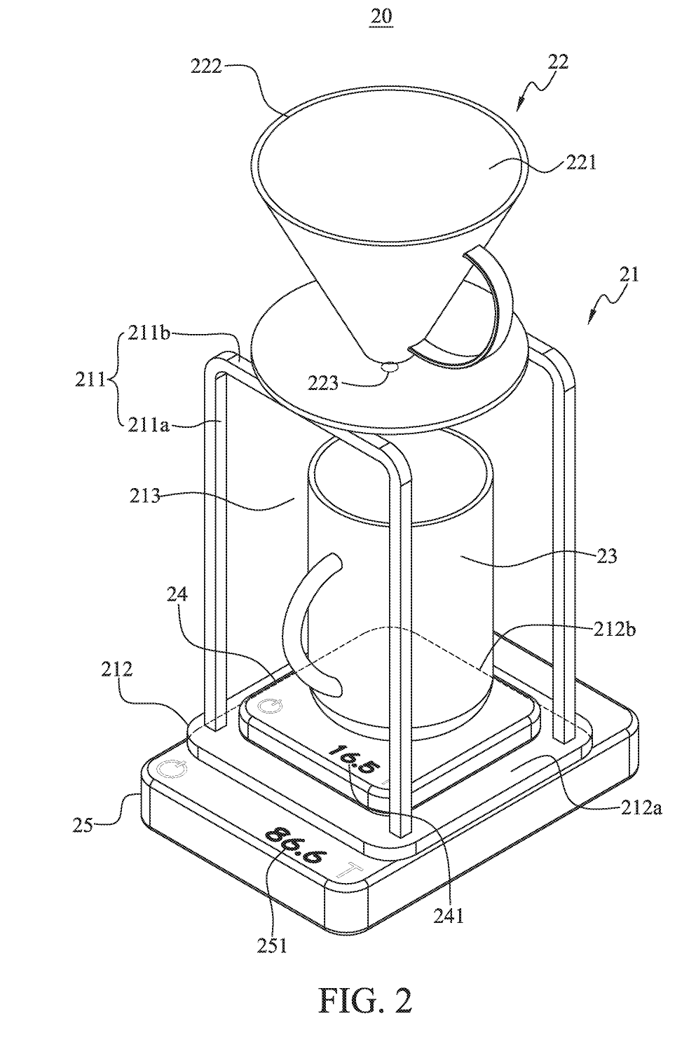

Please refer to FIGS. 1 and 2, which show a method 10 and a device 20, respectively, according to a preferred embodiment of the present invention for examining beverage brewing and extracting process. The examining method 10 is implemented using the examining device 20. As shown in FIG. 2, the examining device 20 includes a support frame 21, an extraction unit 22, an extract liquid container 23, a first measurement unit 24, and a second measurement unit 25.

The support frame 21 includes a set of spaced leg portions 211 and a base portion 212, which together define an open space 213 between them. The leg portions 211 respectively include two sideward spaced connection legs 211a, which are connected at respective lower end to the base portion 212; and a support section 211b connected to between upper ends of the two connection legs 211a and accordingly located at a height above the base portion 212. As can be seen in FIG. 2, the base portion 212 has a horizontal first contact surface 212a and a second contact surface 212b opposite to the first contact surface 212a. A normal direction of the first contact surface 212a is oriented toward the support sections 211b of the leg portions 211.

The extraction unit 22 is assembled to the support sections 211b of the leg portions 211 and defines a downward tapered receiving space 221, which is communicable with the open space 213. The receiving space 221 has a solvent inlet 222 and an extract liquid outlet 223 that has dimensions smaller than that of the solvent inlet 222. The extract liquid outlet 223 defines an outgoing direction toward the base portion 212 of the support frame 21.

The extract liquid container 23 and the first measurement unit 24 are located in the open space 213 provided in the support frame 21 with the extract liquid container 23 positioned on the first measurement unit 24. The first measurement unit 24 is situated on the first contact surface 212a of the base portion 212, so that the first measurement unit 24 is located between the extract liquid container 23 and the base portion 212. Further, the first measurement unit 24 measures an overall weight of the extract liquid container 23 and is provided with a first display zone 241 for displaying a measured weight value. And, since the extraction unit 22 is assembled to the support sections 211b of the support frame 21, a spacing distance 231 is always maintained between the extraction unit 22 and the extract liquid container 23.

The second measurement unit 25 is located beneath the base portion 212 and in contact with the second contact surface 212b of the base portion 212. The second measurement unit 25 measures an overall weight of the support frame 21, the extraction unit 22, the extract liquid container 23 and the first measurement unit 24 and is provided with a second display zone 251 for displaying a measured weight value.

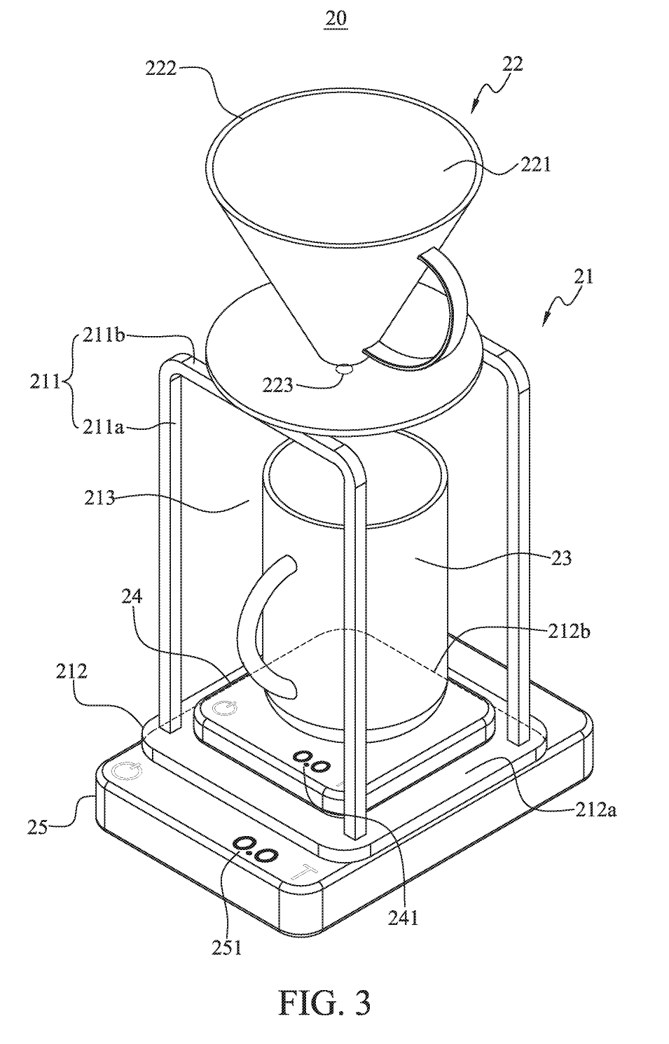

Please refer to FIGS. 1 and 3 at the same time. FIG. 1 shows the examining method 10 includes four steps, namely, Reset step (S1), Brewing step (S2), Measuring step (S3), and Graphing step (S4). To implement the examining method 10 when brewing and extracting a beverage, a sheet of filter paper 26 capable of separating solid substances from liquid is placed in the receiving space 221, such that the filter paper 26 forms a funnel corresponding to the shape of the receiving space 221. At this point, a part of the filter paper 26 covers the extract liquid outlet 223 of the receiving space 221. Then, an amount of solute 30 is positioned on the filter paper 26. In the illustrated embodiment, the solute 30 is coffee powder. However, it is understood the use of coffee powder is only illustrative and not intended to limit the present invention in any way. The examining method 10 of the present invention can be applied to examine the process of brewing other types of solutes, such as green tea powder, red tea powder and other powdery brewing substances.

Thereafter, the first measurement unit 24 and the second measurement unit 25 are turned on. At this point, the first measurement unit 24 measures an overall weight of the extract liquid container 23 and displays the measured weight value in the first display zone 241; and the second measurement unit 25 measures a total weight of the support frame 21, the extraction unit 22, the extract liquid container 23, the first measurement unit 24, the filter paper 26 and the solute 30 and displays the measured weight value in the second display zone 251.

To avoid possible errors in the measured weight of the finally extracted beverage, the first and second measurement units 24, 25 are reset in the Reset step S1, so that the first display zone 241 displays a value of zero and will not measure the weight of the extract liquid container 23 in the subsequent Measuring step S3; and similarly the second display zone 251 also displays a value of zero and will not measure the total weight of the support frame 21, the extraction unit 22, the extract liquid container 23, the first measurement unit 24, the filter paper 26 and the solute 30 in the subsequent Measuring step S3.

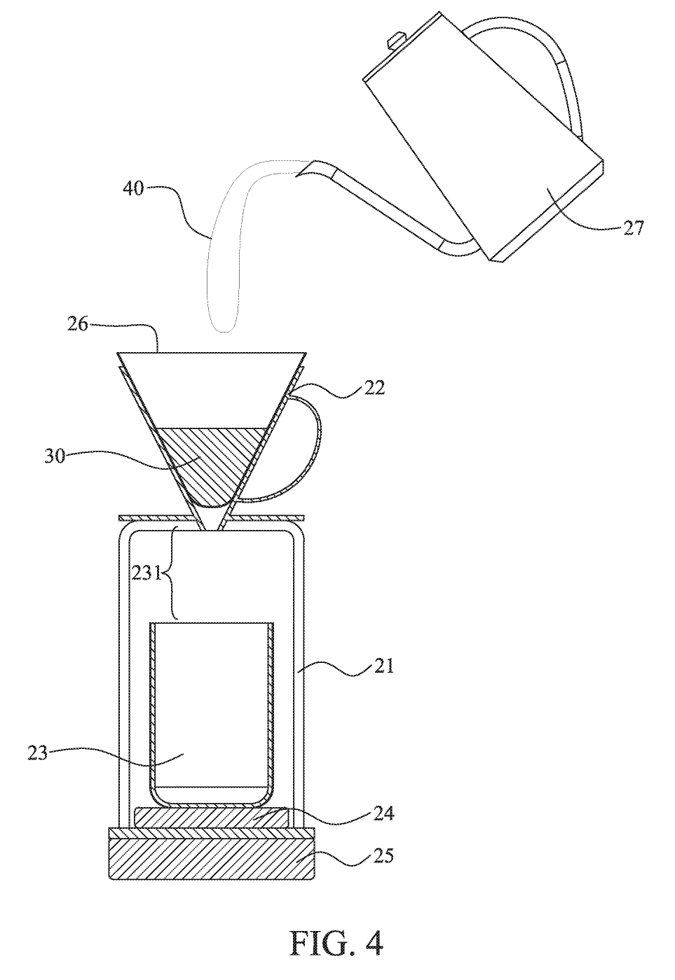

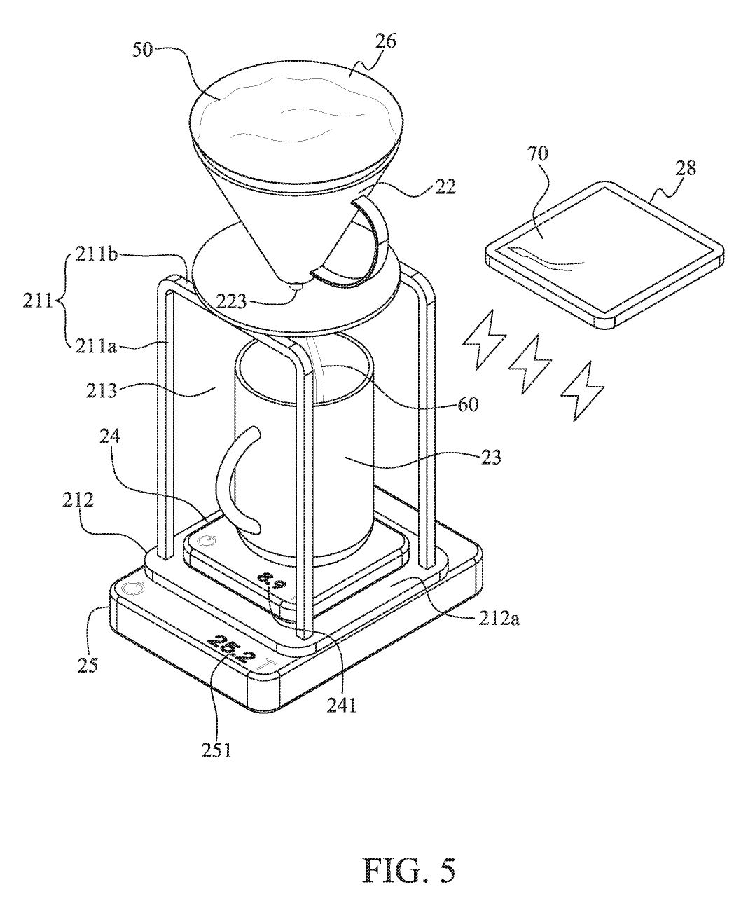

Referring to FIGS. 1 and 4 at the same time. The Brewing step S2 starts after the Reset step S1 is completed. First, use a pour-over kettle 27 to pour an amount of solvent 40 into the receiving space 221 of the extraction unit 22, so that the solute 30 and the solvent 40 are mixed together to produce a solution 50, as shown in FIG. 5. Then, an extract liquid 60 is obtained from the solution 50 with the help of the extraction unit 22 and the filter paper 26 and then flows through the extract liquid outlet 223 of the receiving space 221 into the extract liquid container 23, as shown in FIG. 5. In the illustrated embodiment, the solvent 40 is hot water. However, it is understood the use of hot water is only illustrative and not intended to limit the present invention in any way. In other operable embodiments, the solvent 40 can be any liquid that is able to dissolve the solute 30 and the solution 50 can be coffee, green tea or red tea.

In the illustrated embodiment of the present invention, the solvent 40 can be continuously or intermittently poured from the pour-over kettle 27 into the solute 30 without any particular limit to the way of adding the solvent 40 to the receiving space 221. The way of adding the solvent 40 for brewing a beverage can be adjusted according to an operator's preference.

Please refer to FIGS. 1 and 5 at the same time. The Measuring step S3 is implemented as soon as the Brewing step S2 starts. When the solvent 40 is being poured from the pour-over kettle 27 into the receiving space 221 of the extraction unit 22, the first measurement unit 24 and the second measurement unit 25 synchronously measure weight changes per unit time and transmit the measured values per unit time to an algorithm device 28.

In the illustrated embodiment, the second measurement unit 25 measures the overall weight increase of the extraction unit 22 and the extract liquid container 23 per unit time. Here, the overall weight increase comes from a solvent weight increase during the process of adding the solvent 40 to the solute 30. Meanwhile, the second measurement unit 25 also transmits the measured solvent weight increases per unit time to the algorithm device 28. At this point, the solute 30 and the solvent 40 are mixed together in the receiving space 221 to produce the solution 50. Before the solution 50 permeates through the filter paper 26 in the extraction unit 22, no extract liquid 60 is produced to flow into the extract liquid container 23. Therefore, the first measurement unit 24 does not detect any change of weight in the extract liquid container 23 and a value of zero is shown in the first display zone 241, indicating the current extract liquid weight increase is zero. Nevertheless, the first measurement unit 24 will still transmit the measured extract liquid weight increases per unit time to the algorithm device 28.

When the solution 50 permeates through the filter paper 26 to produce the extract liquid 60, the produced extract liquid 60 flows through the extract liquid outlet 223 of the extraction unit 22 into the extract liquid container 23. Meanwhile, the second measurement unit 25 keeps measuring the solvent weight increases per unit time during the process of adding the solvent 40 to the extraction unit 22 and transmits the measured solvent weight increases per unit time to the algorithm device 28. Meanwhile, the first measurement unit 24 also measures the container-alone weight increase per unit time of the extract liquid container 23. The container-alone weight increase per unit time comes from the extract liquid weight increase per unit time of the produced extract liquid 60. The first measurement unit 24 also transmits the measured extract liquid weight increases per unit time to the algorithm device 28. The solvent weight increase per unit time and the extract liquid weight increase per unit time at a given time can be the same or different in weight. In addition, in the Measuring step S3, a total solvent weight of the solvent 40 added is larger than a total extract liquid weight of the produced extract liquid 60.

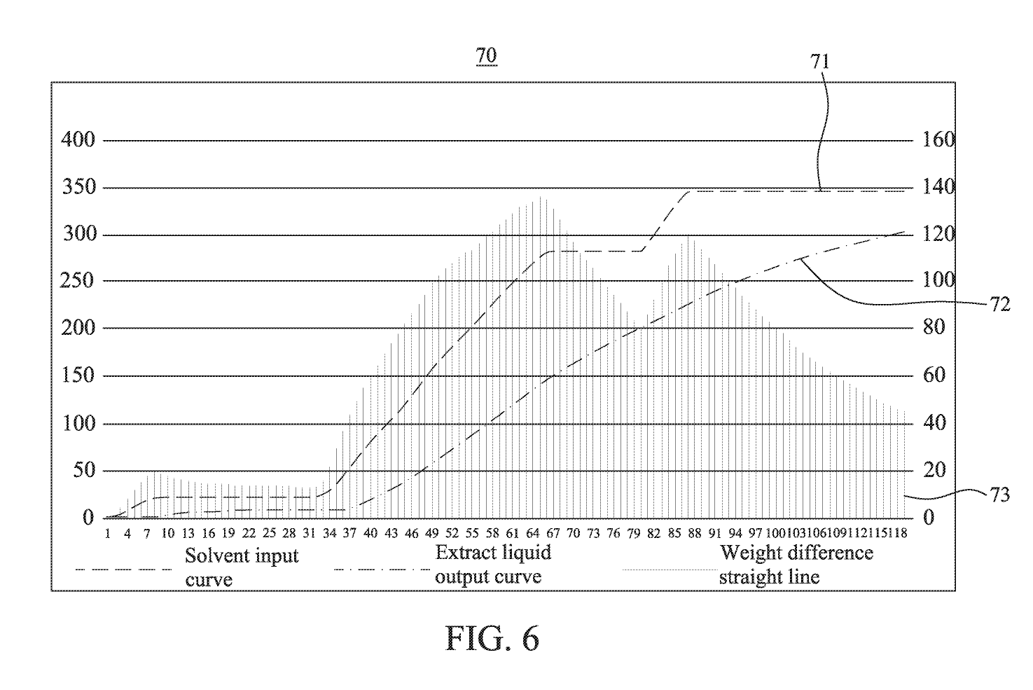

Please refer to FIGS. 1 and 6 at the same time. The graphing step S4 starts as soon as the algorithm device 28 receives the solvent weight increases and the extract liquid weight increases transmitted from the second measurement unit 25 and the first measurement unit 24, respectively. The algorithm device 28 performs a calculation and outputs a graphic data 70 that represents the process of extraction. As shown in FIG. 6, the graphic data 70 includes a solvent input curve 71 that is plotted based on the solvent weight increases per unit time, an extract liquid output curve 72 that is plotted based on the extract liquid weight increases per unit time, and a plurality of weight difference straight lines 73. Each of the weight difference straight lines 73 represents a weight difference between the extract liquid weight increase per unit time and the solvent weight increase per unit time measured at the same time point. From the solvent input curve 71, a brewing operator can have an idea about the changes in the weight of the solvent 40 during the brewing process. From the extract liquid output curve 72, the brewing operator can have an idea about the changes in the weight of the extract liquid 60 during the process the produced extract liquid 60 flows into the extract liquid container 23. From the weight difference straight lines 73, the brewing operator can have an idea about the weight difference between the added solvent and the produced extract liquid per unit time. Therefore, by referring to the solvent input curve 71, the extract liquid output curve 72 and the weight difference straight lines 73 in the graphic data 70, the brewing operator can always ensure a consistent taste for the brewed solution 50, i.e. coffee, red tea or green tea. Or, based on the solvent input curve 71, the extract liquid output curve 72 and the weight difference straight lines 73 in the graphic data 70, the brewing operator can determine the process correctness when brewing the solution 50 the next time. In the illustrated embodiment, whenever the algorithm device 28 receives the solvent weight increase per unit time and the extract liquid weight increase per unit time, it will immediately perform a calculation on the solvent weight increase and the extract liquid weight increase received at the specific unit time to output the solvent input curve 71, the extract liquid output curve 72 and the weight difference straight lines 73.

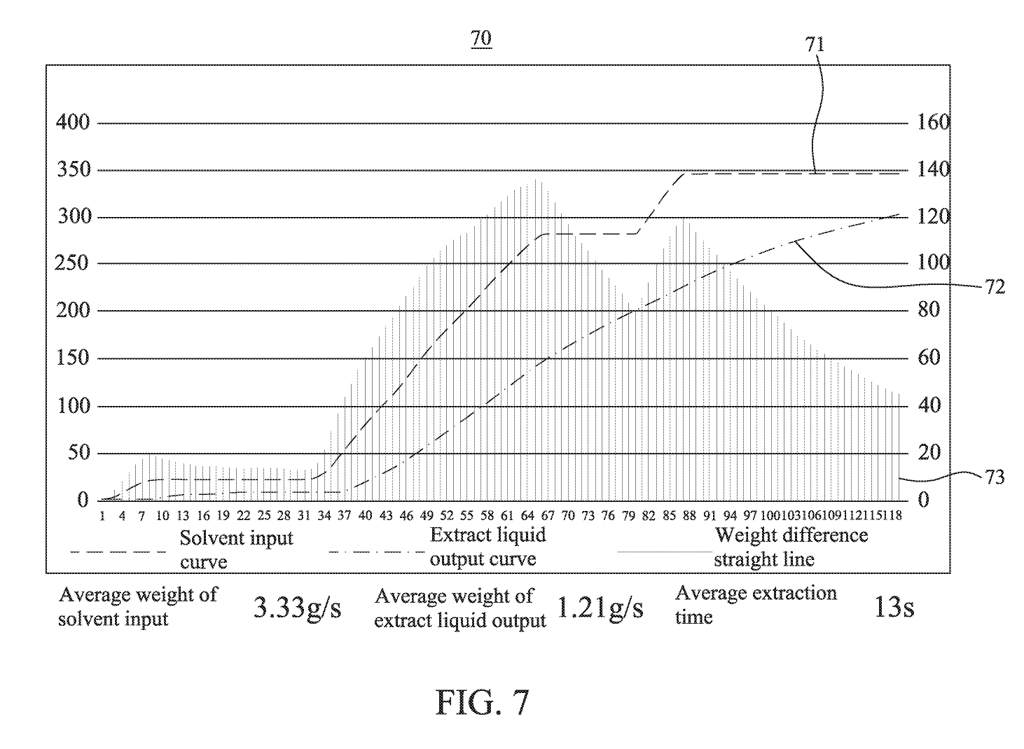

Referring to FIG. 7. For a brewing operator to always ensure a consistent taste for the brewed solution 50 in an easy manner, the algorithm device 28 will perform a calculation and output data of average weight of solvent input, average weight of extract liquid output, and average extraction time based on the last solvent weight increase per unit time, the last extract liquid weight increase per unit time, and the total measuring time. The provision of the average weight of solvent input, the average weight of extract liquid output and the average extraction time can assist the brewing operator in always ensuring a consistent taste for the brewed solution 50.

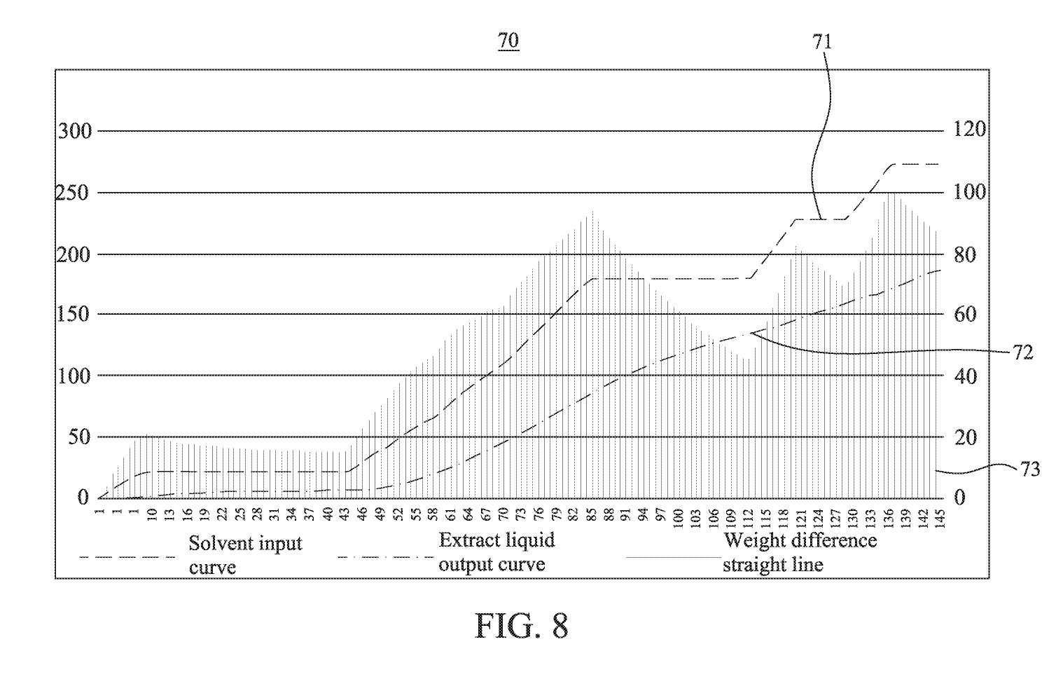

Please refer to FIG. 8. The porosity of the filter paper 26, the grain size of the solute 30 and the speed at which the solvent 40 is being poured into the extraction unit 22 all have an influence on the solvent input curve 71, the extract liquid output curve 72, the weight difference straight lines 73, the average weight of solvent input, the average weight of extract liquid output, and the average extraction time. Therefore, the brewing operator may brew the solution 50 according to personal preference to create a unique graphic data 70.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method for examining beverage brewing and extracting process, comprising the following steps:
adding a solvent to a solute, mixing the solvent and the solute together to produce a solution, and subjecting the solution to an extraction process to output an extract liquid;
measuring a solvent weight increase per unit time of the added solvent and measuring an extract liquid weight increase per unit time of the output extract liquid at the same time during the step of adding the solvent to the solute; and
performing a calculation on the solvent weight increase and the extract liquid weight increase to output a graphic data to represent the extraction process.

2. The examining method as claimed in claim 1, wherein the solvent is added to an extraction unit in which the solute is placed; the solvent and the solute being mixed together in the extraction unit to produce the solution, the produced solution being subjected to the extraction process in the extraction unit to output the extract liquid, and the extract liquid flowing from the extraction unit into an extract liquid container.

3. The examining method as claimed in claim 2, wherein, during the step of adding the solvent to the solute, a second measuring unit is used to measure an overall weight increase of the extraction unit and the extract liquid container per unit time, and a first measurement unit is used at the same to measure a container-alone weight increase of the extract liquid container per unit time.

4. The examining method as claimed in claim 3, further comprising a reset step prior to the step of adding the solvent to the solute; the first measurement unit and the second measurement unit being reset to zero in the reset step, so that the first measurement unit will not measure a weight of the extract liquid container in the subsequent measuring step and the second measurement unit will not measure a total weight of the extraction unit and the extract liquid container in the subsequent measuring step.

5. The examining method as claimed in claim 3, wherein the first measurement unit and the second measurement unit simultaneously transmit the container-alone weight increase per unit time and the overall weight increase of the extraction unit and the extract liquid container per unit time, respectively, measured at the same time point to an algorithm device; and the algorithm device performing the calculation on the container-alone weight increase per unit time and the overall weight increase of the extraction unit and the extract liquid container per unit time that are measured at the same time point.

6. The examining method as claimed in claim 1, wherein, during the adding step, the solvent can be added to the solute continuously or intermittently.

7. The examining method as claimed in claim 1, wherein a total solvent weight of the solvent added to the solute is larger than a total extract liquid weight of the produced extract liquid.

8. The examining method as claimed in claim 1, wherein the graphic data includes a solvent input curve, an extract liquid output curve, a plurality of weight difference straight lines, an average weight of solvent input, an average weight of extract liquid output, and an average extraction time.

9. A device for examining beverage brewing and extracting process, comprising:
an extract liquid container;
a first measurement unit located under the extract liquid container for measuring a container-alone weight of the extract liquid container per unit time;
an extraction unit located above the extract liquid container and having a solvent inlet, an extract liquid outlet, and a receiving space defined in the extraction unit between the solvent inlet and the extract liquid outlet;
a support frame, to which the extraction unit is connected, such that a spacing distance is kept between the extraction unit and the extract liquid container; and
a second measurement unit located beneath the support frame and the first measurement unit for measuring a total weight of the extract liquid container, the first measurement unit, the extraction unit and the support frame.

10. The examining device as claimed in claim 9, wherein the support frame includes a base portion and a set of spaced leg portions; the base portion being located between the first and the second measurement unit; each of the leg portions being connected at an end to the base portion and at another end to the extraction unit.

11. The examining device as claimed in claim 9, further comprising an algorithm device, which is simultaneously wirelessly connected to the first and the second measurement unit; and the algorithm device being capable of receiving the measured container-alone weight of the extract liquid container and the measured total weight of the extract liquid container, the first measurement unit, the extraction unit and the support frame.
